(19) United States
(12) Patent Application Publication
(10) Pub. No.: US 2015/0278264 A1
(43) Pub. Date: Oct. 1, 2015

(54) DYNAMIC UPDATE OF CORPUS INDICES FOR QUESTION ANSWERING SYSTEM

(71) Applicant: International Business Machines Corporation, Armonk, NY (US)

(72) Inventors: Naveen G. Balani, Mumbai (IN); Amit P. Bohra, Pune (IN); Krishna Kummamuru, Bangalore (IN)

(73) Assignee: International Business Machines Corporation, Armonk, NY (US)

(21) Appl. No.: 14/230,212

(22) Filed: Mar. 31, 2014

(51) Int. Cl. G06F 17/30

(52) U.S. Cl. CPC G06F 17/30321; G06F 17/3053

(57) ABSTRACT

Updating corpus indexes with derived analysis data including question data, answer data, and/or research data. The derived analysis data generated during question answering (QA) sessions of a QA system.

### BACKGROUND OF THE INVENTION

The present invention relates generally to the field of question answering systems, and more particularly to indices for question answering systems. Question answering (QA) is a computer science discipline within the fields of information retrieval and natural language processing (NLP) concerned with building computer systems that automatically answer questions posed by humans in a natural language. A QA system may construct its answers by querying a structured database of knowledge or an unstructured collection of natural language documents, each referred to herein as a knowledge base, or an input corpus.

QA systems typically include an input corpus from which it identifies answers to the questions that are asked. For efficient performance of the QA system, indices are created, which are available for use during the run time phase, for querying the knowledge base. The knowledge base is pre-processed using various NLP techniques to derive meaning out of the knowledge base so that these indices may be created.

In known QA systems, the index is intermittently updated. More specifically, in known QA systems, new loads of information (for example, digital documents) are added to the pre-existing corpus. When a new load of information is added, the QA system index is updated based on the content of the added information. The process of updating the index includes: (i) organizing the corpus to incorporate the new information; and (ii) extracting knowledge from the new information. For example, consider an example where a new load of digital documents related to amphibian animals is added to a corpus. The index is updated at that time to add new indices, such as “frogs” and “amphibians.” Also, pre-existing indices, such as “swimming,” are updated to link some of the new content to the pre-existing indices.

### SUMMARY

A method for updating a corpus index of a question answering system, the method including: determining an answer to a question with reference to a corpus and a corresponding corpus index; collecting derived data generated from determining the answer; and updating the corpus index based, at least in part, on the derived data.

### BRIEF DESCRIPTION OF THE SEVERAL VIEWS OF THE DRAWINGS

FIG. 1 is a schematic view of a first embodiment of a networked computers system according to the present invention;

FIG. 2 is a flowchart showing a process performed, at least in part, by the first embodiment computers system;

FIG. 3 is a schematic view of a portion of the first embodiment system;

FIG. 4 is a schematic view of a second embodiment of a networked computers system; and

FIG. 5 is a flowchart showing a process performed, at least in part, by the second embodiment system.

### DETAILED DESCRIPTION

In some embodiments of the present invention, the QA system index is revised based upon user questions and/or the processing performed by the QA system in answering user questions. Consider an example where a QA system is answering many questions from many users. As the questions are being answered by the QA system, the indice “frog” is consulted 1,000 times by the QA system. It is determined that over those 1,000 consultation instances of the indice “frog,” the indice “toad” is also consulted in 907 times. In this simple example, the QA system revises the QA system index such that the indice “frog” and “toad” cross-link to each other based on the high proportion of times that QA searches for the indice “frog” also have historically implicated the indice “toad.” This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

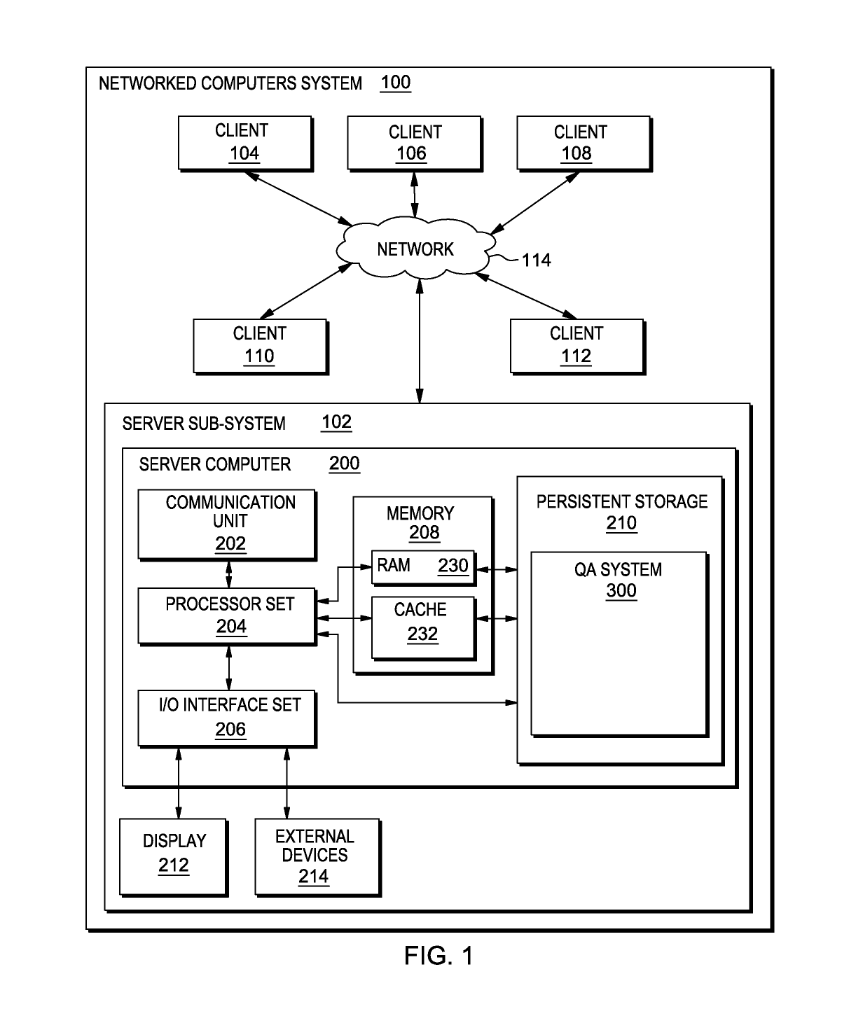

An embodiment of a possible hardware and software environment for software and/or methods according to the present invention will now be described in detail with reference to the Figures. FIG. 1 is a functional block diagram illustrating various portions of a networked computers system 100, including: question answering (also called “server”) sub-system 102; client sub-systems 104, 106, 108, 110, 112; communication network 114; question answering (also called “server”) computer 200; communication unit 202; processor set 204; input/output (i/o) interface set 206; memory device 208; persistent storage device 210; display device 212; external device set 214; random access memory (RAM) devices 230; cache memory device 232; and program (also called “QA system”) 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. EXAMPLE EMBODIMENT

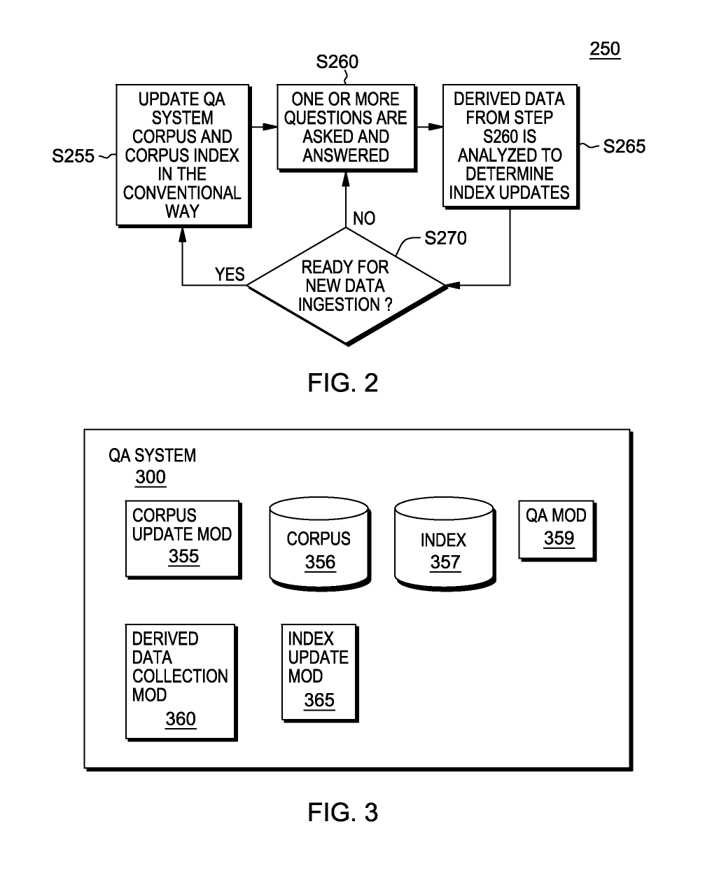

FIG. 2 shows a flow chart 250 depicting a method according to the present invention. FIG. 3 shows program 300 for performing at least some of the method steps of flow chart 250. This method and associated software will now be discussed, over the course of the following paragraphs, with extensive reference to FIG. 2 (for the method step blocks) and FIG. 3 (for the software blocks).

Processing begins at step S255, where corpus update module 355 performs conventional updates of corpus 356 (and its associated index 357) used by question answering (QA) system 300. The data that makes up corpus 356 is obtained from various sources that are periodically updated by revision and/or addition of new loads of information, such as digital documents. The periodic updates generally include updates to both corpus 356 and corpus index (or, simply, index) 357. For example, a new digital document about wildlife habitats is added to corpus 356. The corpus is updated according to conventional practices to include habitat information. The corpus index is updated to include new indices, “habitat” and “pond.”

Processing proceeds to step S260, where: (i) QA mod 359 answers questions posed by users using machine logic, such as analytics code, by reference to index 357 and corpus 356; and (ii) derived data collection module 360 collects derived data. In this example, the derived data will be one of the following types: (i) derived question data relating to the questions (for example, the text of the questions themselves); (ii) derived answer data relating to the content of the answers to the questions that are sent back to the requesting users (for example, the text of the answers themselves); and/or (iii) derived research information relating to the manner in which QA mod 359 performs its “research” to obtain answers to the questions (for example, the indices of index 357 consulted by QA mod 359 in answering the questions).

For example, a user asks the QA system, “Where can I find a frog in its natural habitat?” Derived data module 360 collects derived question data indicating that two corpus pre-existing indices, “frog” and “habitat,” are present in the pending question. As QA mod 359 determines an answer to the question, it consults the recently-added indices “frog” and “habitat.” The fact that mod 359 consults the indices “frog” and “habitat” is saved in derived data mod 360 as derived research data. The answer determined by mod 359, based on information in corpus 356, is as follows: “A frog's natural habitat is a pond that supports the growth of leafy plants.” This answer, which is delivered by QA mod 359 to the requesting user, is also stored as derived answer data in derived data mod 360. As will be discussed further below, derived question data, derived answer data and/or derived research data can take one of two basic forms: (i) language data (for example, “a frog's natural habitat is a pond that supports the growth of leafy plants”; and/or (ii) statistics data (for example, 1 equals the number of times indice “frog” and indice “habitat” have both been consulted in answering a question).

Processing proceeds to step S265, where index update module 365 analyzes the derived data in derived data collection module 360 to determine how to update index 357 based on the derived data that has been collected during step S260 (note, the number of questions, or the amount of time passage before processing proceeds from step S260 to S265 is a matter of system design). It is noted that this update is not being made in connection with any ingestion of new data into corpus 356 and is based upon the answering of questions during normal operations of the QA system.

More specifically, mod 365 applies a set of index change rules to the derived data. When an index change condition associated with an index change rule is met, then mod 365 will make a change to index 357 based on the derived data and the index change rule who's condition is met. Two types of index change conditions include: (i) analytics-based conditions; and/or (ii) statistics-based conditions. An analytics-based index change condition is when a subject matter connection between two or more indices is determined through understanding of the meaning of language similar to the manner in which a human would understand language. In this example, the derived answer data (in the form of language data) obtained at step S260 was: “a frog's natural habitat is a pond that supports the growth of leafy plants.” Accordingly, an analytics based rule in mod 365 determines that there is a strong subject matter connection between the following indices: “frog” and “habitat.” On the other hand, the analytics based rules are sophisticated enough to determine that there is not a strong subject matter connection between some of the other indice words used in the question, such as between “frog” and “plants.” Accordingly, at step S265 index update mod updates index 357 based on the derived answer data by establishing new cross-links between the following pairs of pre-existing indices: “frog,” and “habitat.”

At step S265, mod 365 will also apply statistical rules to the derived data to determine whether there are any changes to be made to index 357 based on the derived data that is statistically based. An example of this sort of change, dealing with “frogs” and “toads” is discussed above at the beginning of this Detailed Description section. In that example, the “statistical rule” has the following statistics-based conditions: (i) a given indice (in this case “frog” is consulted 1000 times; and (ii) another indice is also consulted in at least 90 percent of those user questions in which the primary indice (in this case, “frog”) is consulted. As discussed above, if “frog” is consulted 1000 times, and the secondary indice “toad” is consulted on 907 of those 1000 user questions where “frog” is consulted, then “toad” would meet the statistics-based condition of this exemplary statistical rule. In this example, the statistics based consequence of the statistical rule is that the index is revised so that “frog” (the primary indice) and “toad” (the secondary indice) now cross-link each other as cross-linking indices. This statistical rule is different than an analytics based rule because it does not rely on any determination about the respective human-understandable meanings of the terms “frog” and “toad.”

The updating performed at step S265 by index update mod 365 may affect any field present in index 357. The fields of index 357 are shown in Table 1, below:

TABLE 1
Input corpus index.

| Indice | Meaning | Links to Indices | Links to Corpus |
|---|---|---|---|
| CHINA | Object | Table wear | A95B62, G10X38, |
| | | Porcelain | N66G78 |
| | | Plates | |
| CHINA | Place | Asia | N21A05, J45Z02 |
| | | Tianjin | |
| | | Great Wall | |
| | | General Tso | |

Alternatively, indexes according to various embodiments of the present invention may include more or fewer fields. Also, some indexes suitable for use with the present invention may have data structures that are more sophisticated and/or different to the relatively simple tabular structure of index 357.

Processing proceeds to step S270, where index update module 365 determines whether the QA system is ready for new data ingestion. If there is no new data to ingest, then processing loops back to step S260, where the QA system continues its normal operation. Alternatively, the determination is based on a level of “informativeness” of the corpus updates (discussed in more detail in the Further Comments and/or Embodiments Section, below). Alternatively, the determination is based on the time elapsed since the last corpus update. If it is determined that a corpus update is warranted, processing proceeds to step S255 for a conventional corpus updating process.

### III. FURTHER COMMENTS AND/OR EMBODIMENTS

Some embodiments of the present invention recognize the following facts, potential problems and/or potential areas for improvement with respect to the current state of the art: (i) conventional QA system index revisions are based only on information obtained from the content of information being added to the corpus; and/or (ii) conventional QA systems do not leverage the content of user queries as a basis for making revisions to the QA system index; and/or (iii) conventional QA systems do not leverage the processing that occurs when responding to user queries as a basis for making revisions to the QA system index.

Some embodiments of the present invention may include one, or more, of the following features, characteristics and/or advantages: (i) input corpus indices are improved by incorporating the learned knowledge and the derived data (also herein referred to as “derived analysis data”) based on what the corpus provides; (ii) when a QA system answers any question, derived analysis data is generated in the form of intermediate data; (iii) question analysis generates derived analysis data; (iv) corpus analysis generates derived analysis data; (v) use of derived analysis data to update corpus indices; (vi) derived information and indices are updated during data ingestion and also between data ingestion cycles; (vii) while answering questions substantial derived analysis data is generated by the QA system in the form of intermediate data; (viii) the QA system utilizes resources that may be reused for subsequent questions; (ix) when answering a question, the numerous intermediate data produced include information about the context of the question such as derived data; (x) while determining an answer for a question many indices are consulted by the QA answering algorithm of the QA system, which means that a single answering session can provide a large amount of derived data; (xi) organizing, or cleaning, new data as part of answering a question by leveraging the analysis data generated while answering the question; (xii) organizing, or cleaning, new data as part of answering a question by leveraging the intermediate data generated while answering the question; (xiii) extracting knowledge from new data as part of answering a question by leveraging the analysis data generated while answering the question; and/or (xiv) extracting knowledge from new data as part of answering a question by leveraging the intermediate data generated while answering the question.

The concept of intermediate data may be thought of as annotations on the question text that are created by analyzing the question text. Generally speaking, all of the computational and linguistic analysis performed on the question and its potential answer(s) produce intermediate data. For example, the question, “who is the current president of the United States,” may be asked of a QA system. Analysis of this question will result in an understanding that the question is of the lexical answer type (LAT) “president/person.” If the question were “what is the capital of India,” the LAT would be “capital/location.” In the example question the word “Who” may be replaced by the answer to form a grammatically correct sentence. If, for this normal sentence, there are corresponding evidences in input corpus, then there is some assurance that it could be the correct answer. For a QA system, the word “Who” is referred to as the focus. Intermediate data, discussed herein at length, may include one, or more, of the following: (i) linguistic analysis data; (ii) potential search hits; (iii) search hit scores; (iv) evidence supporting the use of potential search hits as an answer; and/or (v) features that are used to score an answer. Intermediate data is sometimes referred to as a common analysis structure (CAS) in the unstructured information management architecture (UIMA) framework.

Some embodiments of the present invention may include one, or more, of the following features, characteristics and/or advantages: (i) a method for using the derived analysis data to improve both performance and answering capabilities for subsequent questions; (ii) a method for updating an input corpus index dynamically to improve both performance and answering capabilities for subsequent questions; (iii) use of derived analysis data generated as a part of the question and answer process to update the input corpus indices dynamically; (iv) comparing the derived data with the existing data and/or indices to identify any data that is missing from the input corpus, or knowledge base; (v) QA system performance is enhanced as missing indices are automatically created by the QA system as it continuously learns from the derived analysis data; (vi) QA system answering capability is incrementally improved as dynamically created indices support answering subsequent questions related to the derived analysis data; (vii) new indices are dynamically created using the derived analysis data; (viii) providing new and/or updated corpus indices for use in an ongoing question and answer session, that is, in real time; (ix) continuously updating the input corpus indices dynamically by using the derived data from question and response analysis in a QA system; and/or (x) processing derived data by identifying all the annotations discovered while answering previous questions.

Some embodiments of the present invention may further include one, or more, of the following features, characteristics and/or advantages: (i) determining an incremental corpus by applying a set of heuristics using the difference between existing corpus data and generated analysis data, or intermediate data; (ii) identifying relevant incremental corpus segments by considering each segment's contribution to the response based on the scores of the top responses for the question; (iii) identifying the incremental corpus using a set of heuristics based on analysis of derived data generated during question answering in a QA system; (iv) filtering and scoring the incremental corpus segments by considering the contribution of various segments to the score of the top answers for a question (the top answers are based on ranking of what may be hundreds of features that are extracted by the QA system before generating the answers; (v) continuously updating the corpus indices dynamically based on the incremental corpus identified using derived data analysis; (vi) dynamically generated derived information is indexed at runtime; (vii) the input corpus is enhanced and/or updated incrementally based on data derived from analyzing the question and determining possible responses; (viii) using derived data generated as a part of the QA process to update the indices dynamically by comparing the derived data with the existing input corpus to identify any missing information; (ix) upon responding to a question, identifies any new indices to be created out of the derived analysis data for use in updating existing indices dynamically; (x) upon responding to a question, identifies any new indices to be created out of the derived analysis data for use in answering subsequent questions; (xi) missing indexes are automatically created by the QA system because it is continuously learning from its derived data; and/or (xii) increased answering capability where derived indices assist in answering questions related to derived data.

Some embodiments of the present invention may further include one, or more, of the following features, characteristics and/or advantages: (i) continuously and dynamically updated input corpus index by applying derived data from question and response analysis in a QA system; (ii) processing the derived data and extracting the meaningful information, including: (a) (LAT) (that is, the type of answer to a particular question), (b) focus, (c) generic relations, and/or (d) evidence passages; (iii) filtering an incremental corpus by scoring the relevant segments depending on the contribution of each segment to the score generated for an answer; (iv) generating and/or updating the indices of the input corpus; (v) processing the derived data by identifying all the annotation discovered while answering each question; (vi) determining the incremental corpus by applying a set of heuristics using the difference of the input corpus data and the newly generated data; (v) filtering relevant data out of the incremental corpus by considering the contribution of each incremental corpus to the score of the top answers to the question; and/or (vi) updating corpus data on the fly reduces conventional time associated with preprocessing the corpus for each question.

Typically, when a conventional QA system answers a question there is a lot of intermediate data produced. In some embodiments of the present invention, intermediate data is mined for useful information (that is, “derived data”) about the context of the question. More particularly, when a QA system prepares an answer for a given question the input corpus indices are consulted, resulting in intermediate data from which derived data is derived. In some embodiments, the process is “dynamic,” which mean that the corpus indices are updated (or at least potentially updated) relatively frequently (for example, every time a new question is answered). This dynamic updating process supports the efficient answering of subsequent questions using the updated input corpus.

An exemplary method for updating the knowledge base of a QA system includes the following steps: (i) for every question, dump the derived analysis data generated by the QA system (ii) process the derived data to extract any meaningful information (such as LAT, focus, generic relations, and evidence passages); (iii) use a set of configuration and heuristics to determine an updated “incremental corpus” (including an index, new derived data, and so on); (iv) filter the incremental corpus by scoring various derived data segments using their contribution to generate a score for the top answers to a question; and (v) create an updated “final index” based on the information which could be used for subsequent questions.

For step (iii), above, where the potential new knowledge and associated incremental corpus is determined, the existing corpus of data is compared to the derived data generated during the QA process. Comparison is made using a set of heuristics and a set of configurations. These heuristics and configurations are configurable. For example, a set of configurations may include: (i) consider only the top five “evidences” for determining the potential incremental corpus; and/or (ii) consider passages which have more than an average score value. An example of a set of heuristics is: (i) associate a LAT from question analysis with the top contributing evidence passage representing the top answers provided and update the indices (such as {title,LAT} links to document, passage in document).

For item (iv), above, filtering and scoring the new knowledge data, or incremental corpus, is based on a score of the informativeness of the incremental corpus. When sufficient informativeness is identified for an incremental corpus, it is added to the original corpus, or knowledge base, in the form of indices and/or derived analysis data. The informativeness of an incremental corpus may be based upon, for example, determining how many times a particular incremental corpus is used to help answer subsequent questions after being made available to the QA system. For example, an incremental corpus is identified and stored in temporary storage. When performing analysis on subsequent questions, responses are cross-checked with data inside the temporary store to determine how many of the subsequent questions and corresponding answers are related to the data in the temporary store. The determination may include one, or more, of the following factors: (i) term frequency; (ii) related concepts; (iii) number of times an answer is determined; (iv) number of times an answer is not determined. These factors support determination of the score, which is a function of these factors. Each incremental corpus is scored based on how useful its information is depending on its contribution and/or presence in top answers to the question (this activity may be done in the background along with the actual QA processes). If the score exceeds a particular threshold, then this potential incremental corpus becomes a part of the actual corpus, or knowledge base.

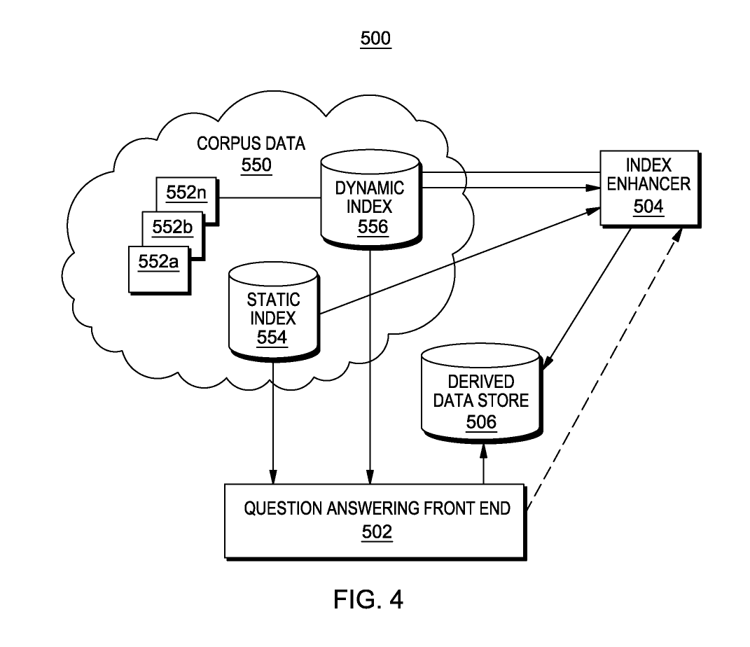

FIG. 4 is a schematic view of QA system 500 for answering questions based on an indexed corpus. QA system 500 includes: QA front end 502; index enhancer module 504; derived data store 506; corpus data store 550; corpus data portions 552a to 552n; static index 554; and dynamic index 556.

In this embodiment, index enhancer 504 is an online module that receives notice from QA front end 502 when a question has been asked, and a provisional response to the question determined, in the conventional way. The index enhancer reads the existing indices and the derived data to determine, based on the derived data, whether to make any: (i) additional indices; and/or (ii) updates to the input corpus. Alternatively, the index enhancer can be an offline module that works in a batched, or scheduled, mode.

Dynamic index 556 is a new set of indices that reflects: (i) the static indexes; and (ii) updates to the static indexes that have been made based on the derived data received and analyzed since the last time the static index was updated. In this embodiment, each time a new question is asked and provisionally answered, the dynamic index is updated by the index enhancer. Derived data store 506 stores the derived data that has been collected since the last time the static index was updated. This derived data includes: (i) question analysis data; (ii) response analysis data; and (iii) the “evidence” used to determine the response. The term “evidence” refers to any data that supports a potential answer. For each potential answer, the QA system returns to the input corpus and searches it again to determine the relevancy of the answers. The response returned from this search is one form of evidence. In this example, question analysis data includes: (i) the text of the questions themselves; (ii) LAT; (iii) question form; and/or (iv) question context.

Response analysis data, as discussed herein, includes: (i) response score; and/or (ii) confidence score. Evidence data, as discussed herein, includes: (i) percent of contribution of each document considered for a particular response. The derived data store stores the derived data in various forms, including: (i) logs; and/or (ii) “not only structured query language” (NoSQL).

The following example is used for a simplified discussion of the steps in flowchart 400. Corpus data 550 contains two documents, corpus data portion 552a and 552b. Data portion 552a is a description of “Washington” state and data portion 552b is a description about George “Washington.” Static index 554 includes the term “Washington” to which each data portion 552a and 552b includes pointers.

The first question entered into the QA system is, “What is the population of Washington?” Upon performing deep analysis of the question, the QA system derives that the term “Washington,” as used in this question, refers to the geographic region designated as the state of Washington (using LAT analysis results). Further, the QA system determines that corpus data portion 552a provides a strong contribution to the response. The data derived from working through this question is stored in derived data store 506.

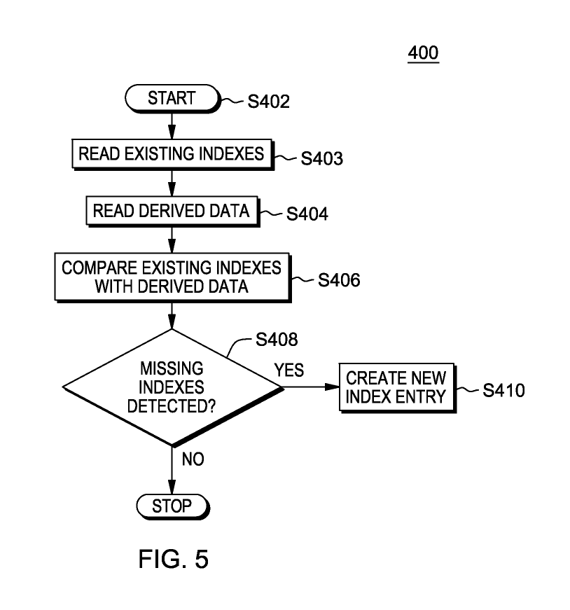

FIG. 5 depicts flow chart 400 for a method according to the present invention. Processing begins at step S402, where question answering system determines a set of responses to a first question.

Processing proceeds to step S403, where index enhancer 504 reads static index 554. At this time there is no data in dynamic index 556.

Processing proceeds to step S404, where index enhancer 504 reads derived data store to identify data derived by QA system 502 while determining the response to the first question.

Processing proceeds to step S406, where index enhancer 504 compares the available indices in static index 554 with the derived data to support a determination as to whether new indices should be created.

Processing proceeds to step S408, where index enhancer 504 determines whether or not a new index entry should be created. If not, processing ends. If one or more indices are to be created, processing proceeds to step S410.

Processing proceeds to step S410, where index enhancer 504 creates a new index entry in dynamic index 556. The new entry reflects that “Washington” in context of “geographic location” is discussed in data portion 552a.

Continuing with the example above, a second question asked of the QA system is, “What is the largest forest area in Washington?” Upon performing deep analysis of the question, the input corpus index now suggests that the term “Washington” is a geographic location. Accordingly, the QA system refers to data portion 552a in determining the response to the second question.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Software storage device: any device (or set of devices) capable of storing computer code in a manner less transient than a signal in transit.

Tangible medium software storage device: any software storage device (see Definition, above) that stores the computer code in and/or on a tangible medium.

Non-transitory software storage device: any software storage device (see Definition, above) that stores the computer code in a non-transitory manner.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

What is claimed is:

1. A method for updating a corpus index of a question answering system, the method comprising:
determining an answer to a question with reference to a corpus and a corresponding corpus index;
collecting derived data generated from determining the answer; and
updating the corpus index based, at least in part, on the derived data.

2. The method of claim 1 wherein the derived data includes at least one of the following: question data, answer data, and/or research data.

3. The method of claim 1 wherein the derived data is in at least one of the following forms: (i) language data, and/or (ii) statistics data.

4. The method of claim 1 wherein the answer is a plurality of possible answers and further comprises:
assigning a score for each of the plurality of possible answers; and
determining a subset of the derived data for updating the corpus index based, at least in part, on the score.

5. The method of claim 4 wherein the subset of the derived data includes only the derived data that contributed to the answer assigned the highest score from among the plurality of possible answers.

6. The method of claim 1 wherein the updating step occurs in real-time.

7. A computer program product for updating a corpus index of a question answering system, the computer program product comprising a computer readable storage medium having stored thereon:
first program instructions programmed to determine an answer to a question with reference to a corpus and a corresponding corpus index;
second program instructions programmed to collect derived data generated from determining the answer; and
third program instructions programmed to update the corpus index based, at least in part, on the derived data.

8. The computer program product of claim 7 wherein the derived data includes at least one of the following: question data, answer data, and/or research data.

9. The computer program product of claim 7 wherein the derived data is in at least one of the following forms: (i) language data, and/or (ii) statistics data.

10. The computer program product of claim 7 wherein the answer is a plurality of possible answers and the computer program product further comprises computer readable storage medium having stored thereon:
fourth program instructions programmed to assign a score for each of the plurality of possible answers; and
fifth program instructions programmed to determine a subset of the derived data for updating the corpus index based, at least in part, on the score.

11. The computer program product of claim 10 wherein the subset of the derived data includes only the derived data that contributed to the answer assigned the highest score from among the plurality of possible answers.

12. The computer program product of claim 7 wherein the updating step occurs in real-time.

13. A computer system for updating a corpus index of a question answering system, the computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to determine an answer to a question with reference to a corpus and a corresponding corpus index;
second program instructions programmed to collect derived data generated from determining the answer; and
third program instructions programmed to update the corpus index based, at least in part, on the derived data.

14. The computer system of claim 13 wherein the derived data includes at least one of the following: question data, answer data, and/or research data.

15. The computer system of claim 13 wherein the derived data is in at least one of the following forms: (i) language data, and/or (ii) statistics data.

16. The computer system of claim 13 wherein the answer is a plurality of possible answers and the program instructions further include:
fourth program instructions programmed to assign a score for each of the plurality of possible answers; and
fifth program instructions programmed to determine a subset of the derived data for updating the corpus index based, at least in part, on the score.

17. The computer program product of claim 16 wherein the subset of the derived data includes only the derived data that contributed to the answer assigned the highest score from among the plurality of possible answers.

18. The computer system of claim 13 wherein the updating step occurs in real-time.
